(19) United States
(12) Patent Application Publication
(10) Pub. No.: US 2010/0074465 A1
(43) Pub. Date: Mar. 25, 2010

(54) METHOD FOR ANALYZING A HUMAN HEAD

(75) Inventor: Dirk Schneemann, Langenhagen (DE)

Correspondence Address: GIFFORD, KRASS, SPRINKLE,ANDERSON & CITKOWSKI, P.C, PO BOX 7021, TROY, MI, 48007-7021, US

(73) Assignee: Schneemann System GmbH, Langenhagen (DE)

(21) Appl. No.: 12/339,297

(22) Filed: Dec. 19, 2008

(30) Foreign Application Priority Data
Sep. 19, 2008 (DE) DE 102008048142.4

(51) Int. Cl. G06K 9/00

(52) U.S. Cl. 382/100

(57) ABSTRACT

The invention relates to a method and apparatus for analyzing a human head according to psycho-physiognomy, and offers an at least partly automated analysis. However, it can also perform such an analysis independently or without any intervention by an analyst or any other person, so that the method offers a fully automated analysis. The method for analyzing a human head includes the steps of establishing a computerized system having a computer unit; providing a reference model with a model reference point in the computerized system; providing a database with a plurality of contents in the computerized system; generating an image of a human head; transmitting the image to the computerized system; fixing a image reference point in the image; comparing the image reference point with the model reference point to determine a deviation; assigning a numerical value to the determined deviation; and assigning a content of the database to the obtained numerical value.

### CROSS-REFERENCE TO RELATED APPLICATIONS

This application claims priority to German patent application DE 10 2008 048 142.4 filed Sep. 19, 2008.

### FIELD OF THE INVENTION

The present invention relates to a method for analysing a human head.

### BACKGROUND OF THE INVENTION

EP 0 984 386 B1 discloses a method for detecting a human face in an image. In this known method, a candidate face region is localized in the image and this candidate face region is analysed with regard to a first characteristic which identifies a first facial feature. The first characteristic has a substantially symmetric horizontal brightness profile which has a maximum arranged between a first and a second minimum. The analysis step comprises the step of forming a vertical integral projection of part of the candidate face region and the step of determining whether the vertical integral projection has a first and second minimum, which are arranged substantially symmetrically with respect to a maximum. The analysis step comprises the step of subdividing part of the candidate face region into a left and right half, the step of forming a horizontal integral projection of each half and the step of comparing a measure of a horizontal symmetry of the left and right horizontal integral projections with a first threshold value.

The prior art furthermore discloses psycho-physiognomy, which teaches that each human body part has a significance, with in particular face, eyes, nose, mouth, ears, facial and body expressions as well as body language, including gestures and gesticulations, of a human being analysed using tried and tested principles. For example, the shape of the nasal root supplies statements about the life zone with the expression of spiritual impulses in the interaction with other people, the energy use becomes apparent at the temples, the forehead regions express spiritual activity, the upper forehead allows recognition of goodwill and affection and the chin and lower jaw provide information on motivation and assertiveness.

### SUMMARY OF THE INVENTION

It is an object of the present invention to provide a method and apparatus to assist in the analysis of a human head.

This object is achieved by a method for analysing a human head comprising the steps of: establishing a computerized system having at least one computer unit; providing at least one reference model of at least one part of a human head in the computerized system, said at least one reference model having at least one model reference point; providing at least one database in the computerized system, said database having a plurality of contents; generating at least one image of at least one part of a human head; transmitting said image to the computerized system; fixing at least one image reference point in said image; comparing said at least one image reference point with said at least one model reference point to determine at least one deviation; assigning at least one numerical value to said at least one deviation; and assigning the obtained at least one numerical value to at least one content of the database.

This proposed method can thus assist an analyst in analysing a human head, in particular analysing a human head according to psycho-physiognomy, so that the proposed method offers an at least partly automated analysis. In the partially automated analysis, an analyst accesses the image of the human head, the reference model, and the database through the computerized system and may perform at least one of the remaining steps in the method for analyzing a human head. However, the proposed method and apparatus can also analyse a human head, in particular analyse a human head according to psycho-physiognomy, independently or without any intervention by an analyst or any other person so that the proposed method offers a fully automated analysis through the use of software generated procedures.

The image reference points and/or the contents of the database, which preferably comprise and/or relate to and/or describe the characteristics of the human having the head, in particular personality traits, can preferably be fixed and/or selected and/or grouped in terms of prescribed basic parameters or areas of interest, such as, for example, upbringing, partner selection, education, sport, staff selection, potential analysis, fostering talents, coaching development measures, training development measures, team development measures, consulting projects, sales qualifications, scouting and development of athletes or job selection.

The image can be designed arbitrarily as necessary and can be, for example, a two-dimensional or three-dimensional image. A two-dimensional image can be a photograph, for example, and can, for example, show the head from the front or from one side. The photograph could have been recorded by a digital camera, so that it is present in digital form as an image file, or it could also have been recorded by an analogue camera, so that it is present as a negative or paper print. A negative or paper print can be converted into digital form in a known manner, for example with the aid of a scanner, and stored as an image file. The image file from the digital camera can be fed into the computerized system, so that the image is transmitted to the computerized system. The image reference point can be selected arbitrarily as necessary, and can be, for example, the centre of the pupil of an eye of the head, the central point between the eyes of the head, or the tip of the nose or chin. If necessary, it is also possible to use two or more images, each of which can be formed arbitrarily as necessary and can be, for example, a two-dimensional or a three-dimensional image.

The reference model can be designed arbitrarily as necessary and can, for example, comprise a three-dimensional model of a reference head. If necessary, it is possible to use, for example, a single, universal reference model which, in particular, is applicable independently of sex, age and ethnicity. However, if necessary, it is also possible to use two or more reference models, each of which can be designed arbitrarily as necessary and can comprise, for example, a three-dimensional model of a reference head. The reference models can be designed, for example, specifically according to sex and/or age and/or ethnicity. Thus, by way of example, a first reference model could relate to the head of a woman and a second reference model could relate to the head of a man.

Provision can be made for at least two neighbouring, in particular adjoining, regions to be fixed in the image. Here, “neighbouring” refers to those regions which do not overlap. The regions can be formed and arranged arbitrarily as necessary and can comprise, for example, the left and/or right eye, the left and/or right ear, the left and/or right temple, the left and/or right cheek, the forehead, the nose, the mouth and/or the chin.

Provision can also be made for the image reference point to be fixed in a region assigned to it. Preferably, at least one image reference point is fixed in each of the fixed regions.

Furthermore, provision can be made for numerical values to be assigned to the deviations of at least one image reference point, which lies within one of the regions, from at least one model reference point. It will be appreciated that the term deviation relates to the positional difference between the image reference point and the model reference point. The deviation between the image reference point and the model reference point may optionally include not only a positional difference between the two points but also an orientation that represents the direction of the positional difference. As such, the deviation represents a vector, having both magnitude (i.e. the positional difference) and direction, between the image reference point and the model reference point.

Moreover, provision can be made for at least one numerical value of a region to be combined with at least one other numerical value of the same region and/or with at least one numerical value of at least one other region when assigning the contents of the database to the numerical values. In this manner it is possible to combine different deviations with one another and/or opposing influences can be taken into account. Preferably, at least one result of such a combination is assigned to at least one content of the database. The combination can be carried out arbitrarily as necessary. Thus, by way of example, according to a first possibility, the numerical values of a first region can be firstly combined amongst themselves and—in parallel or deferred with respect to the first combination—a second combination of numerical values of a second region can be carried out amongst themselves, and subsequently a third combination of tie results of the first combination and the results of the second combination can be carried out. Or, for example, according to a second possibility, the numerical values of a first region can firstly be combined with the numerical values of a second region and this can be followed by a second combination of the results of the first combination amongst themselves. Or, for example, according to a third possibility, it is possible that firstly there is a first combination of numerical values of a first region with numerical values of a second region, followed by a second combination of the results of the first combination with the numerical values of a third region and then a third combination of the results of the second combination amongst themselves. Or, for example, according to a fourth possibility, it is possible that firstly there is a first combination of numerical values of a first region with the numerical values of a second region and—in parallel or deferred with respect to the first combination—a second combination of the numerical values of the second region with the numerical values of a third region can be carried out and subsequently there can be a third combination of the results of the first combination with the results of the second combination. Or, for example, according to a fifth possibility, it is possible that firstly there is a first combination of numerical values of a first region with the numerical values of a second region and—in parallel or deferred with respect to the first combination—a second combination of the numerical values of a third region with the numerical values of a fourth region can be carried out and subsequently there can be a third combination of the results of the first combination with the results of the second combination.

Furthermore, provision can be made for the regions to comprise and/or relate to physical features of the head, in particular shapes, dimensions and proportions of the head. Additionally, provision can be made for the image reference points to comprise and/or relate to physical features of the head, in particular shapes, dimensions and proportions of the head. The physical features can be selected arbitrarily as necessary and for example relate to the spacing of the eyes, the shape and size of the nose or the thickness of the lips, or describe how close the ears lie to the skull or stand away from the skull.

The abovementioned regions can preferably be fixed and/or selected and/or grouped in terms of prescribed basic parameters or areas of interest, such as, for example upbringing, partner selection, education, sport, staff selection, potential analysis, fostering talents, coaching development measures, training development measures, team development measures, consulting projects, sales qualifications, scouting and development of athletes or job selection.

Furthermore, provision can be made for the contents of the database to comprise and/or relate to characteristics of the person having the head, in particular personality traits. By way of example, the characteristics can comprise courage, selfishness, assertiveness, expressiveness, attitude towards life, perfection, realization, sensitivity to criticism, etc.

Provision can be made for the image reference points to be fixed in the image with the aid of the computerized system. It follows that the fixation can be carried out at least in partly automated fashion, preferably in fully automated fashion.

Provision can also be made for deviations of the image reference points from the model reference points to be determined with the aid of the computerized system. It follows that the determination can be carried out at least in partly automated fashion, preferably in fully automated fashion.

Furthermore, provision can be made for the deviations to be assigned numerical values with the aid of the computerized system. It follows that the assignment can be carried out at least in partly automated fashion, preferably in fully automated fashion.

Moreover, provision can be made for the contents of the database to be associated with the numerical values with aid of the computerized system. It follows that the association can be carried out at least in partly automated fashion, preferably in fully automated fashion.

Furthermore, provision can be made for the images to be transmitted to the computerized system with the aid of a data transmission system, in particular the internet. It follows that the association can be carried out at least in partly automated fashion, preferably in fully automated fashion.

Furthermore, provision can be made for the associated contents of the database, preferably with the aid of the computerized system, to be sent to a person, preferably with the aid of a data transmission system, in particular the internet. It follows that the transmission can be carried out at least in partly automated fashion, preferably in fully automated fashion. The associated contents can preferably be sent in a processed form, which comprises further descriptions such as explanations and comments in addition to the actual contents.

### BRIEF DESCRIPTION OF THE DRAWINGS

Further advantageous embodiments of the present invention will be explained in more detail with reference to the following drawings. However, individual features emerging from this are not limited to the individual embodiments, but can be combined with individual features described above or with individual features of other embodiments to form other embodiments. The details in the figures are only intended to be explanatory, but not limiting. In the figures:

FIG. 1 shows a schematic diagram of a method for analysing a human head;

FIG. 2 shows a schematic sketch of a second embodiment of combining numerical values of two regions in one image; and

FIG. 3 shows a schematic sketch of a third embodiment of combining numerical values of two regions in one image.

### DETAILED DESCRIPTION OF THE PREFERRED EMBODIMENTS

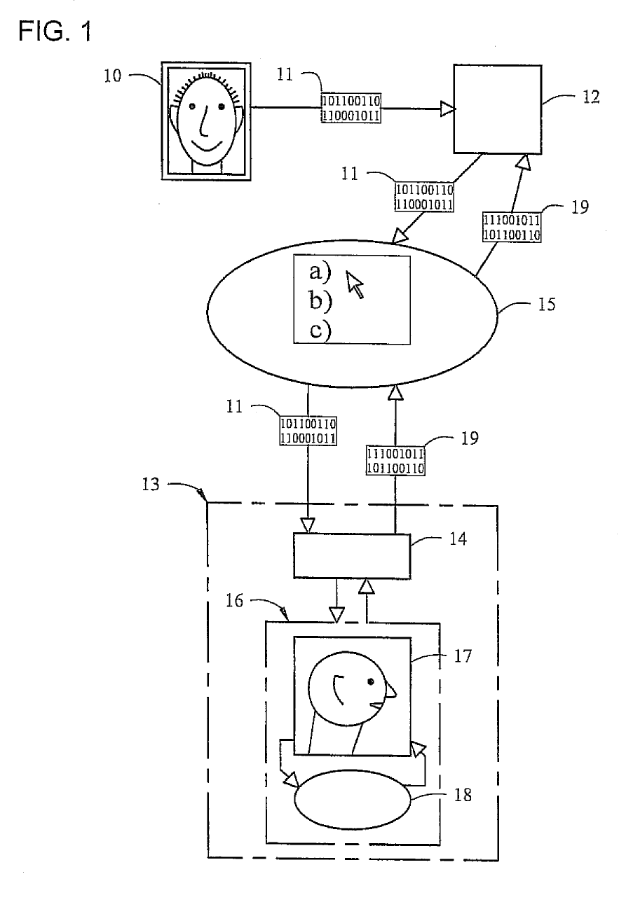

The present invention has utility as a method and apparatus for analyzing a human head. FIG. 1 provides an overview of a first embodiment of a method for analysing a human bead. A customer or user creates a two-dimensional image 10 of his head in the form of a frontal photograph with the aid of a digital camera (not illustrated here), which stores the image in the form of a digital image file 11.

Subsequently, the customer transfers the image 10, or to be precise the image file 11, with the aid of a computer 12 with an internet connection to a computerized system 13 with at least one computer unit 14, which maintains a web portal 15 on the internet. For this purpose, the user with the computer 12 visits the web portal 15 via the internet and uploads the image file 11 to the computer unit 14. In this first embodiment, the web portal 15 offers three different types a), b) and c) of image analysis, and in the current example the customer selects image analysis type a), according to which a frontal image is analysed with respect to a predetermined number N of features.

In a subsequent step, the system 13 examines the uploaded image file 11 for the purposes of quality assurance, and informs the customer via the web portal 15 whether the image file 11 is suitable for the desired image analysis type or not. Should the image file 11 be unsuitable, the customer is prompted via the web portal 15 to upload a different image file 11.

Should the image file 11 be suitable, the customer is prompted via the web portal 15 to enter the data necessary for payment. The system 13 checks these payment data, and should they be considered to be valid, the system 13 transfers the image file 11 to an image analysis module 16, which is likewise maintained by the computer unit 14.

The image analysis module 16 maintains a three-dimensional reference model 17 of a human head with a predetermined number M of model reference points—in this case the predetermined number M of model reference points is equal to N times B, with the factor B being explained below—and a database 18. The image analysis module 16 is designed such that it independently fixes N regions on the image 10 or the image file 11; that in each of the N regions it fixes for the respective region a predetermined number of image reference points (in this case, the predetermined number of image reference points is equal to B for each of the N regions); that it determines for each image reference point a deviation from predetermined model reference points; that it assigns a numerical value to each determined deviation; and that it associates each numerical value with a predetermined content of the database 18. For this purpose, the database 18 comprises links between all possible numerical values which, in the case of this first embodiment, comprise, relate to and/or describe shapes, dimensions and proportions of the head, and different contents, which comprise, relate to and/or describe the personality traits of the person having this head. Hence, overall there are M=N×B model reference points, there are B image reference points in each of the N regions, that is to say in all N regions together G=N×B image reference points (here G=M), there is one deviation for each image reference point and one numerical value for each deviation, that is to say in each of the N regions there are B deviations and B numerical values, and in all N regions together there are C deviations and G numerical values.

Furthermore, the image analysis module 16 is designed so that, while associating the contents of the database 18 with the numerical values, it independently combines different deviations, or to be precise their numerical values, with one another with the aid of a combination, also referred to here as a combination calculation, so as to take into account opposing influences of the features amongst themselves, and that it associates the results of this combination calculation with predetermined contents of the database 18. For this purpose, the image analysis module 16 in the first embodiment carries out the combination calculation according to a first embodiment in such a manner that first of all—in parallel or deferred with respect to one another—it carries out N combinations, namely one combination for each of the N regions, of B numerical values of the respective region amongst each other, that it then groups the N results of these N combinations into P groups each of at least two results in a predetermined manner, and that it subsequently—in parallel or deferred with respect to one another—carries out P further combinations, namely one combination for each of the P groups, of the grouped results of the respective group amongst themselves. The grouping of the N results can be carried out arbitrarily as necessary, for example by the first and second result forming a first group, the second and third result forming a second group, the i-th and (i+1)-th result forming an i-th group, the (N−1)-th and N-th result forming an (N−1)-th group, and the N-th and first result forming an N-th group, so that in this case P=N. However, the N results can also be grouped such that, for example, the first and the N-th result form a first group, the second and the N-th result form a second group, the i-th and the N-th result form an i-th group, and the (N−1)-th group and N-th group form an (N−1)-th group, so that in this case P=N−1.

Furthermore, the image analysis module 16 is designed such that it independently combines the contents obtained in this manner with a corresponding analysis text, and that it stores the result as an analysis file 19, preferably in the pdf format, and transmits it to the web portal 15. The customer can then view this analysis file 19 via the web portal 15, and/or download it onto his computer 12 and/or a different computer (not illustrated here) via the internet and/or have it sent to him via email by the system 13.

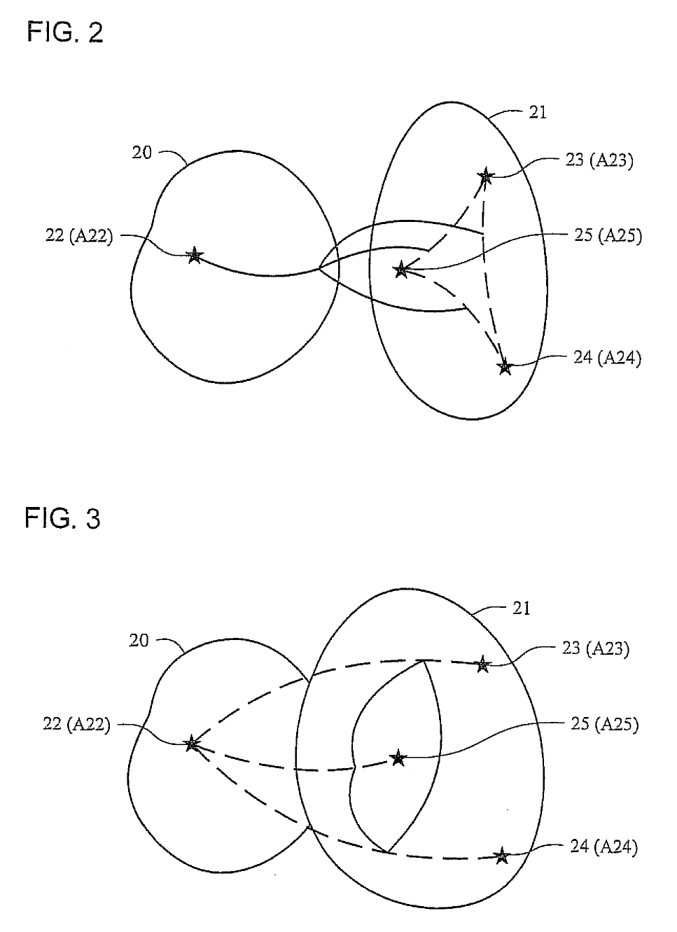

On the basis of FIG. 2, a second embodiment of a combination calculation of numerical values of regions in an image is explained in more detail in the following text. FIG. 2 schematically illustrates a two-dimensional image 10, in which the image analysis module 16 has already fixed two neighbouring regions 20, 21 which are not adjacent. Additionally, the image analysis module 16 has already fixed one image reference point 22 in the first region 20 and three image reference points 23, 24, 25 in the second region 21. Furthermore, the image analysis module 16 has determined for each image reference point 22, 23, 24, 25 a deviation from a respectively associated model reference point (not illustrated here) and has assigned a numerical value A22, A23 A24, A25 to each deviation.

In the case of this second embodiment of the combination calculation, the image analysis module 16 first of all carries out a first combination for the second region 21 by combining all the numerical values A23, A24, A25 amongst themselves (this is indicated in FIG. 2 by the dashed lines), so that a first result is obtained. Then the image analysis module 16 carries out a second combination by combining this first result with the sole numerical value A22 of the first region 20 (this is indicated in FIG. 2 by the solid lines), so that a second result is obtained. Finally, the image analysis module 16 defines this second result as the final result of this combination calculation in the second embodiment. After carrying out the combination calculation, the image analysis module 16 assigns the corresponding result to a content (not illustrated here) of the database 18.

On the basis of FIG. 3, a third embodiment of a combination calculation of numerical values of regions in an image is explained in more detail in the following text. Figure 3 schematically illustrates a two-dimensional image 10, in which the image analysis module 16 has already fixed two neighbouring regions 20, 21 which are adjacent. Additionally, the image analysis module 16 has already fixed one image reference point 22 in the first region 20 and three image reference points 23, 24, 25 in the second region 21. Furthermore, the image analysis module 16 has already determined for each image reference point 22, 23, 24, 25 a deviation from a respectively associated model reference point (not illustrated here) and has assigned a numerical value A22, A23, A24, A25 to each deviation.

In the case of this third embodiment of the combination calculation, the image analysis module 16 first of all carries out a first combination between the two regions 20, 21 by combining the sole numerical value A22 of the first region 20—in parallel or deferred with respect to one another—with each of the numerical values A23, A24, A25 of the second region 21 (this is indicated in FIG. 2 by the dashed lines), so that three first results are obtained. Then the image analysis module 16 carries out a second combination by combining all the three first results amongst themselves (this is indicated in FIG. 2 by the solid lines), so that a second result is obtained. Finally, the image analysis module 16 defines this second result as the final result of this combination calculation in the third embodiment. After carrying out the combination calculation, the image analysis module 16 assigns the corresponding result to a content (not illustrated here) of the database 18.

From the foregoing, it can be seen that there has been provided a method and apparatus for analyzing a human head. Having described the invention, however, many modifications thereto will become apparent to those skilled in the art to which it pertains without deviation from the spirit of the invention as defined by the scope of the appended claims.

It is claimed:

1. A method for analyzing a human head using a computerized system, said method comprising the steps of:
establishing a computerized system having at least one computer unit;
providing at least one reference model of at least one part of a human head in the computerized system, said at least one reference model having at least one model reference point;
providing at least one database in the computerized system, said database having a plurality of contents;
generating at least one image of at least one part of a human head;
transmitting said image to the computerized system:
fixing at least one image reference point in said image;
comparing said at least one image reference point with said at least one model reference point to determine at least one deviation;
assigning at least one numerical value to said at least one deviation; and
assigning the obtained at least one numerical value to at least one content of the database.

2. The method according to claim 1, wherein at least two neighboring regions are fixed in the image.

3. The method according to claim 2, wherein the image reference point is fixed in a region assigned to it.

4. The method according to claim 2, wherein numerical values are assigned to the deviations of at least one image reference point which lies within one of the regions.

5. The method according to claim 2, wherein at least one numerical value of a region is combined with at least one other numerical value of the same region and/or with at least one numerical value of at least one other region while assigning the contents of the database to the numerical values.

6. The method according to claim 2, wherein the regions relate to physical features of the head.

7. The method according to claim 1, wherein the image reference points relate to physical features of the head.

8. The method according claim 1, wherein the contents of the database to characteristics of the person having the head.

9. The method according to claim 1, wherein the image reference points are fixed in the image with aid of the computerized system.

10. The method according to claim 1, wherein deviations of the image reference points from model reference points are determined with the aid of the computerized system.

11. The method according to claim 1, wherein the deviations are assigned numerical values with the aid of the computerized system.

12. The method according to claim 1, wherein the contents of the database are associated with the numerical values with the aid of the computerized system.

13. The method according to claim 1, wherein the image is transmitted to the computerized system with the aid of a data transmission system.

14. The method according to claim 1, wherein the assigned contents of the database are sent to a person.

15. A system for analyzing an electronic image of at least one part of a human head, said system comprising:
a computerized system having at least one database with a plurality of contents, said computerized system having at least one reference model of at least one part of a human head, said at least one reference model having at least one model reference point; and
a computer unit connected to said computerized system to access said database and said at least one reference model, said computer unit operable to receive the electronic image;
said computer unit determines at least one image reference point on the electronic image and compares said at least on image reference point with said at least one model reference point of said at least one reference model to determine at least one deviation;
said computer unit assigns said at least one deviation with at least one numerical value, and associates said at least one numerical value to at least one of said plurality of contents.

16. The system according to claim 15, wherein said computer unit fixes at least two neighboring regions in the image.

17. The system according to claim 16, wherein said computer unit fixes said at least one image reference point in the region assigned to it.

18. The system according to claim 16, said computer unit assigns said at least one numerical value to said at least one deviation of said at least one image reference point which lies in at least one of said regions.

19. The system according to claim 16, wherein said computer unit combines at least one numerical value of a region with at least one numerical value of the same region and/or with at least one numerical value of at least one other region prior to assigning the contents of the database to said at least one numerical value.

20. The system according to claim 16, wherein at least one of said regions, or said at least one image reference point relate to physical features of the head.

21. The system according to claim 15, wherein said plurality of contents relate to personality traits.
